(19) United States
(12) Patent Application Publication
(10) Pub. No.: US 2002/0117563 A1
(43) Pub. Date: Aug. 29, 2002

(54) METHOD FOR SUPPRESSING DISSEMINATION OF DUST FROM A PILE OF DUST-PRODUCING BULK MATERIAL SUCH AS PETROLEUM COKE

(75) Inventor: Timothy R. Lulewicz, Pleasant Prairie, WI (US)

Correspondence Address: THOMPSON COBURN, LLP, ONE FIRSTAR PLAZA, SUITE 3500, ST LOUIS, MO, 63101, US

(73) Assignee: Benetech, Inc.

(21) Appl. No.: 09/792,248

(22) Filed: Feb. 23, 2001

(51) Int. Cl. B05B 15/06

(52) U.S. Cl. 239/722; 239/273; 239/225.1; 169/47; 169/64

(57) ABSTRACT

A method for suppressing dissemination of dust from a pile of dust-producing bulk material, such as a pile of petroleum coke. The pile has a surface. The method comprises placing a sprayer apparatus on the pile, and discharging a liquid from the sprayer in a manner to distribute the liquid to at least an area of the surface of the pile.

### BACKGROUND OF THE INVENTION

This invention relates to methods for suppressing dust emissions from piles of dust producing bulk solid materials.

In many industries, dust-producing bulk solid particulate materials (e.g., petroleum coke, coal, mine mill tailings, fertilizers, etc.) are heaped to form large piles for storage. The piles are generally out in the open and subject to wind and other environmental conditions. Wind blowing over the piles erodes the piles by blowing some of the particulate material off the piles. Wind erosion causes economic waste by depleting material from the piles. Also, the airborne particulate material (i.e., dust emissions) pose environmental, health and safety issues in many industrial environments.

A conventional approach to suppressing dust emissions from a typical pile is to employ fixed spray nozzles to periodically spray water on the pile. Generally, the fixed spray nozzles must be positioned remote from the pile to avoid interfering with necessary equipment. For example, in a typical coke storage yard, stacking and reclaiming equipment is often positioned adjacent the pile on rails on opposite sides of the pile. To make room for the equipment, the fixed spray nozzles are generally no closer than fifty feet from the pile edge. Because the nozzles are positioned a substantial distance from the pile, a relatively high water pressure and flow rate is needed to spray the pile. However, wind often negatively affects the spray trajectory. The wind may cause much of the spray to miss the pile and/or cause portions of the pile to not be sprayed at all, thereby decreasing the effectiveness of the spraying operation. Moreover, because of uncertainty caused by unpredictable wind conditions, pile surface conditioning agents cannot be applied to the pile via the spray nozzles.

### SUMMARY OF THE INVENTION

Among the several advantages of the present invention may be noted the provision of an improved method for suppressing dissemination of dust from a pile of dust-producing bulk material; the provision of such a method which is effective in distributing a liquid to the surface of the pile; the provision of such a method which can compensate for changes in wind speed and wind direction; the provision of such a method which may be employed to distribute water and/or a chemical agent to the pile; and the provision of such a method which may be employed even in harsh operating environments.

In general, a method of the present invention is for suppressing dissemination of dust from a pile of dust-producing bulk material, such as a pile of petroleum coke. The pile has a surface. The method comprises placing a sprayer apparatus on the pile, and discharging a liquid from the sprayer in a manner to distribute the liquid to at least an area of the surface of the pile.

Other advantages and features of the present invention will be in part apparent and in part pointed out hereinafter.

### BRIEF DESCRIPTION OF THE DRAWINGS

FIG. 1 is a top plan view of a sprayer mechanism of the present invention;

FIG. 2 is a side elevational view of the sprayer mechanism of FIG. 1;

FIG. 3 is a side elevational view of the sprayer mechanism of FIGS. 1 and 2 being pushed upward along a surface of a petroleum coke pile via PVC tubing; and

FIG. 4 is a front elevational view of two sprayer mechanisms of the present invention positioned on the petroleum coke pile of FIG. 3.

Corresponding reference characters indicate corresponding parts throughout the several views of the drawings.

### DETAILED DESCRIPTION OF THE PREFERRED EMBODIMENT

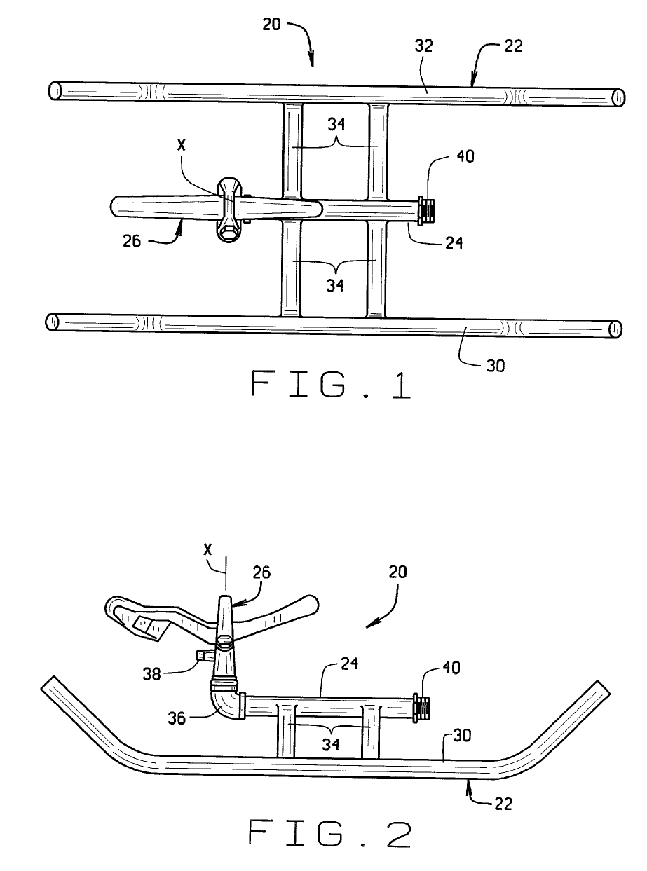

Referring now to the drawings and first more particularly to FIGS. 1 and 2, a sprayer mechanism of the present invention is indicated in its entirety by the reference numeral 20. The sprayer mechanism 20 comprises a sled-like lower portion 22, a central pipe section 24, and a sprinkler head 26. The sled-like lower portion 22 comprises first and second runners 30, 32. Each runner 30, 32 has an upwardly sloping forward end and an upwardly sloping rearward end. Preferably, the runners 30, 32 are rigidly connected to the central pipe section 24 via cross bars 34. The runners 30, 32 enable the sprayer mechanism to slide or glide along a surface of a dust-producing bulk material particulate pile (discussed below) when a pushing or pulling force is applied to the central pipe section. The sprinkler head 26 is preferably connected to a discharge end of the central pipe section 24 via an elbow 36 or some other suitable connector. The sprinkler head 26 is preferably a rotarytype sprinkler of the type conventionally used for lawn irrigation. The sprinkler head 26 has a discharge nozzle 38 through which water or other liquid is discharged. A suitable connector 40 is secured to an intake end of the central pipe section 24 to facilitate attachment of a conduit (discussed below) to the pipe section.

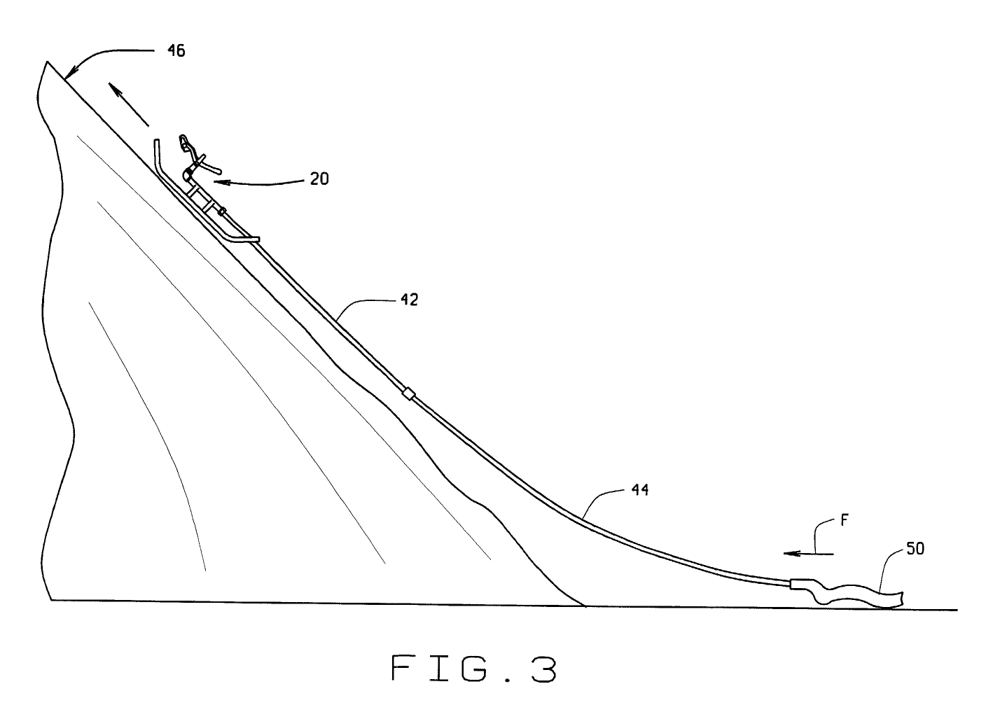

Referring now to FIG. 3, a first feed pipe 42 is releasably connected to the central pipe section 24 of the sprayer mechanism 20 via the connector 40 (FIG. 1 and 2). Although the connector 40 is shown as being a threaded male connector, it is to be understood that the connector could alternatively be a quick-connect connector without departing from the scope of this invention. The first feed pipe 42 is shown in FIG. 3 as connected end-to-end to a second feed pipe 44. The feed pipes 42, 44 have two primary purposes: (1) to act as a conduit to convey liquid from a liquid source to the sprayer mechanism 20 to enable the liquid to be discharged from the mechanism's discharge nozzle 38; and (2) to serve as a push rod to enable a user to push the sprayer mechanism up the side of a pile of dust-producing bulk material, such as a pile of petroleum coke, generally indicated by the reference number 46. Preferably, the feed pipes 42, 44 are sufficiently rigid to enable a user to push the sprayer mechanism 20 upward along the surface of the coke pile 46. More particularly, the feed pipes are preferably sufficiently stiff such that application by the user of a pushing force F at the upstream end of the second feed pipe 44 (i.e., the right most end as viewed in FIG. 3) causes the sprayer mechanism 20 to move upwardly along the inclined surface of the coke pile 46, even when the inclined surface is inclined at a forty-five degree angle from horizontal. Preferably, the feed pipes 42, 44 are of a schedule 80 polyvinyl chloride (PVC), and are more preferably of a schedule 80 CPVC. However, it is to be understood that other suitable tubing, including other types of polymeric tubing may be employed without departing from the scope of this invention. Also, the terms tubing and piping are used herein in a broad sense and are intended to be interchangeable. In other words, the term “pipe” is intended to cover tubes and pipes, and the term “tube” is intended to cover both tubes and pipes. Moreover, although two feed pipes 42, 44 are shown, it is to be understood that one, two, or more feed pipes may be employed without departing from the scope of this invention. What is important is that the feed pipe or feed pipes employed are sufficiently long to enable the user to move the sprayer apparatus 20 to a desired location on the coke pile 46.

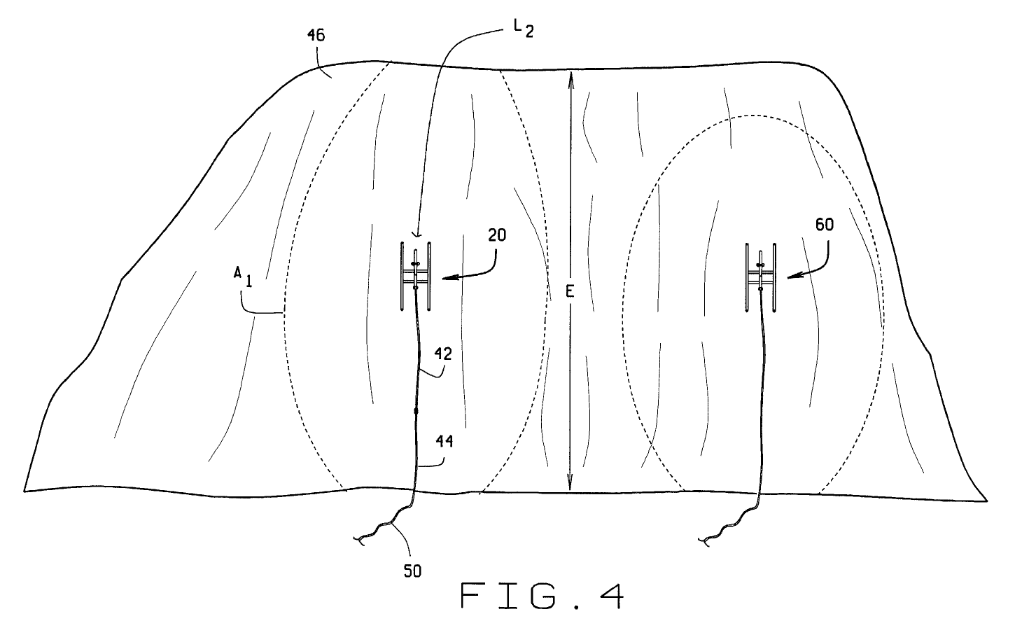

In operation, the intake end of the second feed pipe 44 (i.e., the rightmost end as viewed in FIG. 3) is preferably connected to source of pressurized liquid via a flexible hose 50. The user places the sprayer mechanism 20 near the base (i.e., lowermost part) of the coke pile 46. The user then grasps the second feed pipe 44 and applies the pushing force F thereto to push the sprayer mechanism 20 up the surface of the coke pile 46. As shown in FIG. 4, the sprayer mechanism 20 is pushed up the pile 46 to a first operating location L₁. The liquid from the liquid source (not shown) is then pumped or otherwise transported through the flexible hose 50 and through the feed pipes 42, 44 and to the sprayer mechanism 20 where it is discharged through the discharge nozzle 38 (FIGS. 1 and 2) while the sprayer mechanism is maintained at the first operating location L₁ . As the liquid is being discharged from the discharge nozzle 38, the sprinkler head 26 rotates relative to the central pipe section 24 about an axis X (FIGS. 1 and 2) such that the discharged liquid is distributed to and covers a first area A₁ of the surface of the pile 46 (FIG. 4). Preferably, the liquid is an aqueous mixture comprising a residual dust-control agent, such as that commercially available from Benetech, Inc. (the assignee of the present invention) under the trade designation GDS-12. More preferably, the liquid comprises six parts water and one part the chemical agent. Alternatively or additionally, the liquid may comprise one or more of the following: a pile sealer, an encrusting agent, an anti-oxidizing agent, a spontaneous combustion suppressant, and a liquid fire suppressant. As shown in FIG. 4, the apex of the pile 46 is at an elevation E above the base of the pile. Preferably, the elevation of the first operating location L₁ is sufficiently high (e.g., at an elevation E/2 above the surface of the base) such that the area covered with the liquid extends to the apex. As shown in FIG. 4, the liquid pressure is sufficiently great to cover an area that extends from the apex to the base. However, it is to be understood that smaller areas could be covered without departing from the scope of this invention.

After the first area A₁ is coated with the liquid via the sprayer mechanism 20, liquid flow is stopped and the user moves the sprayer apparatus to a second operating location (not shown) which is spaced from the first operating location L₁. The liquid flow is then turned on to discharge the liquid from the discharge nozzle 38 to coat a second area (not shown) of the surface of the pile 46. Preferably, this process is repeated until the entire pile 46 is coated with the liquid. Additional sprayer mechanisms (a second one of which is indicated generally at 60 in FIG. 4) may be employed and operated simultaneously with the sprayer mechanism 20 to coat the pile more quickly.

Although the sprayer mechanism 20 is preferably maintained in an operating location when liquid is being discharged therefrom, it is to be understood that the sprayer mechanism 20 could be moving while liquid is being discharged. Also, although the sprinkler head 26 is preferably a rotarytype sprinkler head, it is to be understood that other types of sprinkler heads could be employed without departing from the scope of this invention.

In view of the above, it will be seen that the several objects of the invention are achieved and other advantageous results attained.

As various changes could be made in the above constructions and methods without departing from the scope of the invention, it is intended that all matter contained in the above description or shown in the accompanying drawings shall be interpreted as illustrative and not in a limiting sense.

What is claimed is:

1. A method for suppressing dissemination of dust from a pile of dust-producing bulk material, the pile having a surface, the method comprising:
placing a sprayer apparatus on the pile; and
discharging a liquid from the sprayer in a manner to distribute the liquid to at least an area of the surface of the pile.

2. A method as set forth in claim 1 wherein the pile has a base, the base constituting the lower-most portion of the pile, and wherein the step of placing the sprayer apparatus on the pile comprises moving the sprayer apparatus along the surface of the pile to an operating location on the pile, the operating location having an elevation higher than the base of the pile.

3. A method as set forth in claim 2 wherein the step of moving the sprayer apparatus along the surface of the pile comprises pushing the sprayer apparatus along the surface of the pile to the operating location.

4. A method as set forth in claim 3 wherein the sprayer apparatus is maintained in the operating location during the step of discharging the liquid from the sprayer.

5. A method as set forth in claim 3 wherein the sprayer apparatus comprises a sled-like lower portion adapted for sliding along the surface of the pile, and wherein the step of pushing the sprayer apparatus along the surface of the pile comprises pushing the sprayer apparatus in a manner to cause the sprayer apparatus to slide along the surface of the pile.

6. A method as set forth in claim 3 wherein the step of pushing the sprayer apparatus comprises pushing the sprayer apparatus with a conduit, the conduit having a passageway for delivery of the liquid to the sprayer apparatus.

7. A method as set forth in claim 6 wherein the sprayer apparatus comprises a discharge nozzle, wherein the nozzle is in fluid communication with the passageway of the conduit, and wherein the step of discharging the liquid from the sprayer comprises delivering the liquid to sprayer apparatus via the conduit in a manner such that the liquid is discharged from the nozzle.

8. A method as set forth in claim 6 wherein the conduit is a polymeric tube, the polymeric tube being sufficiently rigid to enable a user to push the sprayer apparatus to the operating location with the polymeric tube.

9. A method as set forth in claim 8 wherein the tube comprises a pipe of polyvinyl chloride.

10. A method as set forth in claim 2 wherein the pile has an apex, the apex being at an elevation L above the base, and wherein the operating location is at an elevation of at least L/3 above the base.

11. A method as set forth in claim 10 wherein the operating location is at an elevation of at least L/2 above the base.

12. A method as set forth in claim 2 further comprising the step of maintaining the sprayer apparatus at the operating location during the step of discharging the liquid from the sprayer.

13. A method as set forth in claim 12 wherein the operating location constitutes a first operating location and wherein the area of the surface of the pile constitutes a first area of the surface of the pile, the method further comprising:
moving the sprayer apparatus to a second operating location on the pile, the second operating location being spaced from the first operating location;
maintaining the sprayer apparatus at the second operating location while discharging the liquid from the sprayer to distribute the liquid to a second area of the surface of the pile.

14. A method as set forth in claim 1 wherein the step of placing the sprayer apparatus on the pile comprises placing the sprayer apparatus at a first operating location on the pile, wherein the area of the surface of the pile constitutes a first area of the surface of the pile, and wherein the step of discharging the liquid from the sprayer apparatus comprises discharging the liquid from the sprayer apparatus while the sprayer apparatus is at the first operating location to distribute the liquid to the first area of the surface of the pile, the method further comprising:
moving the sprayer apparatus to a second operating location on the pile, the second operating location being spaced from the first operating location;
discharging the liquid from the sprayer apparatus while the sprayer apparatus is at the second operating location to distribute the liquid to a second area of the surface of the pile.

15. A method as set forth in claim 1 wherein the sprayer apparatus includes a rotary sprinkler head and wherein the step of discharging the liquid from the sprayer comprises discharging the liquid from the rotary sprinkler head.

16. A method as set forth in claim 15 wherein the rotary sprinkler head rotates as the liquid is discharged therefrom.

17. A method as set forth in claim 1 wherein the liquid is an aqueous mixture comprising at least one of the following: a residual dust-control agent, a pile sealer, an encrusting agent, an anti-oxidizing agent, a spontaneous combustion suppressant, and a liquid fire suppressant; and

18. A method for suppressing dissemination of dust from a pile of petroleum coke, the pile having a surface, the method comprising:
placing a sprayer apparatus on the pile; and
discharging a liquid from the sprayer in a manner to distribute the liquid to at least an area of the surface of the pile.

19. A method for treating a pile with a liquid aqueous mixture, the pile having a surface, the method comprising:
placing a sprayer apparatus on the pile; and
discharging the liquid aqueous mixture from the sprayer in a manner to distribute the liquid aqueous mixture to at least an area of the surface of the pile.

20. A method as set forth in claim 19 wherein the step of discharging the liquid aqueous mixture from the sprayer comprises discharging from the sprayer at least one of the following: a residual dust-control agent, a pile sealer, an encrusting agent, an anti-oxidizing agent, a spontaneous combustion suppressant, and a liquid fire suppressant.
